(19) United States
(12) Patent Application Publication
(10) Pub. No.: US 2014/0280530 A1
(43) Pub. Date: Sep. 18, 2014

(54) Live Faces

(71) Applicants: John Torres Fremlin, San Francisco, CA (US); Vladimir Fridman, San Jose, CA (US); Lex Arquette, San Jose, CA (US); Erbil Karaman, San Francisco, CA (US)

(72) Inventors: John Torres Fremlin, San Francisco, CA (US); Vladimir Fridman, San Jose, CA (US); Lex Arquette, San Jose, CA (US); Erbil Karaman, San Francisco, CA (US)

(21) Appl. No.: 13/799,581

(22) Filed: Mar. 13, 2013

(51) Int. Cl. H04L 29/08

(52) U.S. Cl. CPC H04L 67/306
USPC 709/204

(57) ABSTRACT

In one embodiment, a method includes providing for presentation on a graphical user interface an identification of a user; and providing presence information of the user with the identification of the user. The presence information indicates a temporal, spatial, modal, or social accessibility or availability of user. The presence information includes real-time video of the user captured and is provided as presence information automatically and without user input of the user.

### TECHNICAL FIELD

This disclosure generally relates to user interfaces (UI).

### BACKGROUND

A social-networking system, which may include a social-networking website, may enable its users (such as persons or organizations) to interact with it and with each other through it. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g. wall posts, photo-sharing, event organization, messaging, games, or advertisements) to facilitate social interaction between or among users.

The social-networking system may transmit over one or more networks content or messages related to its services to a mobile or other computing device of a user. A user may also install software applications on a mobile or other computing device of the user for accessing a user profile of the user and other data within the social-networking system. The social-networking system may generate a personalized set of content objects to display to a user, such as a newsfeed of aggregated stories of other users connected to the user.

A mobile computing device—such as a smartphone, tablet computer, or laptop computer—may include functionality for determining its location, direction, or orientation, such as a GPS receiver, compass, or gyroscope. Such a device may also include functionality for wireless communication, such as BLUETOOTH communication, near-field communication (NFC), or infrared (IR) communication or communication with a wireless local area networks (WLANs) or cellular-telephone network. Such a device may also include one or more cameras, scanners, touchscreens, microphones, or speakers. Mobile computing devices may also execute software applications, such as games, web browsers, or social-networking applications. With social-networking applications, users may connect, communicate, and share information with other users in their social networks.

### SUMMARY OF PARTICULAR EMBODIMENTS

In particular embodiments, a one or more of images of an entity on the social-networking system, such as for example a user or a business, may be captured and streamed in real-time to provide a non-interactive view of the current activities of the entity. For example, the real-time video status of the user may be presented in multiple areas of the social-networking system, such as for example a profile photo of a profile page, group page membership listing, or a sidebar on “friend's” newsfeed. As another example, the real-time video status of a particular “friend” may be displayed while interacting with the “friend” through instant messaging. Additionally, the real-time video status may provided on third-party websites that the user has a profile. An Internet-connected image sensor may, automatically and without user input, capture and send a video feed of the user. The real-time video status may be captured in various devices such as the image sensor of a laptop, smartphone, or webcam, or a camera in the interior of a car, to provide a real-time video status from a number of locations. As another example, the non-interactive, real-time visual status may, automatically and without user input, capture a video feed a location of the business and provide the real-time video status as a cover photo on a business page on the social-networking system.

In particular embodiments, the real-time video status of one or more “friends” may be displayed as part of a view associated with the social-networking system depending on a score that may be based on proximity of the users on the social-graph or a frequency of interaction between the users. For example, the real-time video status of “friends” with the scores above a pre-determined threshold may be displayed on a side bar of the newsfeed of the user. In particular embodiments, the social-networking system may display the real-time video status of a particular “friend” with whom the user has had a recent interaction, such as sharing a status update tagging the particular “friend”, liking their posts, or writing on their wall, so that the user may see the reaction of the particular “friend” to the activity. In particular embodiments, the user may be able to select the “friends” whose real-time video status will be displayed. In particular embodiments, the user may interact with the displayed real-time video statuses. For example, a video chat with one or more “friends” may be initiated by selecting their real-time video status. As another example, the size of a particular real-time video status may be increased by mousing over one or more displayed thumbnail real-time video statuses. In particular embodiments, the user may customize the real-time video status by for example applying filtering to video stream. In particular embodiments, the social-networking system may apply compression or adjust frame rate of the video status. As an example, the social-networking system may adjust the frame rate to effectively send discreet images captured at pre-determined intervals of time.

In particular embodiments, the user may apply privacy setting to invite particular “friends” to stream their video status, announce to particular “friends” that the user is streaming real-time video status, or define the particular “friends” who are allowed to see video status of the user.

### BRIEF DESCRIPTION OF THE DRAWINGS

FIG. 1 illustrates an example network environment associated with a social-networking system.

FIGS. 2A-D illustrate example wireframes for example user interfaces with example video statuses.

FIG. 3A illustrates an example mobile device.

FIG. 3B illustrates an example wireframe for an example mobile user interface with example video statuses.

FIG. 4 illustrates an example method for providing a real-time video status of a user.

FIG. 5 illustrates an example computing system.

FIG. 6 illustrates an example social graph.

### DESCRIPTION OF EXAMPLE EMBODIMENTS

FIG. 1 illustrates an example network environment 100 associated with a social-networking system. Network environment 100 includes a user 101, a client system 130, a social-networking system 160, and a third-party system 170 connected to each other by a network 110. Although FIG. 1 illustrates a particular arrangement of user 101, client system 130, social-networking system 160, third-party system 170, and network 110, this disclosure contemplates any suitable arrangement of user 101, client system 130, social-networking system 160, third-party system 170, and network 110. As an example and not by way of limitation, two or more of client system 130, social-networking system 160, and third-party system 170 may be connected to each other directly, bypassing network 110. As another example, two or more of client system 130, social-networking system 160, and third-party system 170 may be physically or logically co-located with each other in whole or in part. Moreover, although FIG. 1 illustrates a particular number of users 101, client systems 130, social-networking systems 160, third-party systems 170, and networks 110, this disclosure contemplates any suitable number of users 101, client systems 130, social-networking systems 160, third-party systems 170, and networks 110. As an example and not by way of limitation, network environment 100 may include multiple users 101, client system 130, social-networking systems 160, third-party systems 170, and networks 110.

In particular embodiments, user 101 may be an individual (human user), an entity (e.g., an enterprise, business, or third-party application), or a group (e.g., of individuals or entities) that interacts or communicates with or over social-networking system 160. In particular embodiments, social-networking system 160 may be a network-addressable computing system hosting an online social network. Social-networking system 160 may generate, store, receive, and send social-networking data, such as, for example, user-profile data, concept-profile data, social-graph information, or other suitable data related to the online social network. Social-networking system 160 may be accessed by the other components of network environment 100 either directly or via network 110. Third-party system 170 may be accessed by the other components of network environment 100 either directly or via network 110. In particular embodiments, one or more users 101 may use one or more client systems 130 to access, send data to, and receive data from social-networking system 160 or third-party system 170. Client system 130 may access social-networking system 160 or third-party system 170 directly, via network 110, or via a third-party system. As an example and not by way of limitation, client system 130 may access third-party system 170 via social-networking system 160. Client system 130 may be any suitable computing device, such as, for example, a personal computer, a laptop computer, a cellular telephone, a smartphone, or a tablet computer.

Links 150 may connect client system 130, social-networking system 160, and third-party system 170 to communication network 110 or to each other. This disclosure contemplates any suitable links 150. In particular embodiments, one or more links 150 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout network environment 100. One or more first links 150 may differ in one or more respects from one or more second links 150.

In particular embodiments, client system 130 may be an electronic device including hardware, software, or embedded logic components or a combination of two or more such components and capable of carrying out the appropriate functionalities implemented or supported by client system 130. As an example and not by way of limitation, a client system 130 may include a computer system such as a desktop computer, notebook or laptop computer, netbook, a tablet computer, e-book reader, GPS device, camera, personal digital assistant (PDA), handheld electronic device, cellular telephone, smartphone, other suitable electronic device, or any suitable combination thereof. This disclosure contemplates any suitable client systems 130. A client system 130 may enable a network user at client system 130 to access network 110. A client system 130 may enable its user to communicate with other users 101 at other client systems 130.

In particular embodiments, client system 130 may include an integrated image sensor (e.g. web camera of a mobile computing device or a camera capturing the interior of an automobile) or discrete image sensor (e.g. web or surveillance camera) coupled to client system 130 may be configured to capture individual images or one or more of images at pre-determined intervals as a video status. As an example and not by way of limitation, social-networking system 160 may adjust a frame rate to capture or send images at pre-determined intervals of time. In particular embodiments, one or more images captured by the image sensor may be sent to social-networking 160 or third-party 170 system through network 110. In particular embodiments, images captured by the image sensor of client system 130, may be uploaded to social-networking 160 or third-party 170 system using a program executed on or image-uploading functionality built into the operating system (OS) of client system 130. As an example and not by way of limitation, images captured by the image sensor of client system 130 may be automatically uploaded and streamed to social-networking 160 or third-party 170 system in substantially real-time as a video status of user 101. In particular embodiments, user 101 may customize the real-time video status by applying filtering (e.g. sepia) to the images captured by the image sensor of client system 130. In particular embodiments, the social-networking 160 or third-party system 170 may adaptively apply compression, or adjust the frame rate or resolution of the video status based at least in part on the bandwidth of the connection over network 110.

In particular embodiments, client system 130 may include a web browser 132, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. User 101 at client system 130 may enter a Uniform Resource Locator (URL) or other address directing the web browser 132 to a particular server (such as server 162, or a server associated with a third-party system 170), and the web browser 132 may generate a Hyper Text Transfer Protocol (HTTP) request and communicate the HTTP request to server. The server may accept the HTTP request and communicate to client system 130 one or more Hyper Text Markup Language (HTML) files responsive to the HTTP request. Client system 130 may render a webpage based on the HTML files from the server for presentation to the user 101. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, social-networking system 160 may be a network-addressable computing system that can host an online social network. Social-networking system 160 may generate, store, receive, and send social-networking data, such as, for example, user-profile data, concept-profile data, social-graph information, or other suitable data related to the online social network. Social-networking system 160 may be accessed by the other components of network environment 100 either directly or via network 110. In particular embodiments, social-networking system 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 162 may include hardware, software, or embedded logic components or a combination of two or more such components for carrying out the appropriate functionalities implemented or supported by server 162. In particular embodiments, social-networking system 164 may include one or more data stores 164. Data stores 164 may be used to store various types of information. In particular embodiments, the information stored in data stores 164 may be organized according to specific data structures. In particular embodiments, each data store 164 may be a relational, columnar, correlation, or other suitable database. Although this disclosure describes or illustrates particular types of databases, this disclosure contemplates any suitable types of databases. Particular embodiments may provide interfaces that enable a client system 130, a social-networking system 160, or a third-party system 170 to manage, retrieve, modify, add, or delete, the information stored in data store 164.

In particular embodiments, social-networking system 160 may store one or more social graphs in one or more data stores 164. In particular embodiments, a social graph may include multiple nodes—which may include multiple user nodes (each corresponding to a particular user) or multiple concept nodes (each corresponding to a particular concept)—and multiple edges connecting the nodes. Social-networking system 160 may provide users 101 of social-networking system 160 the ability to communicate and interact with other users 101. In particular embodiments, users may join the online social network via social-networking system 160 and then add connections (e.g. relationships) to a number of other users of social-networking system 160 whom they want to be connected to. Herein, the term “friend” may refer to any other user 101 of social-networking system 160 with whom user 101 has formed a connection, association, or relationship via social-networking system 160.

In particular embodiments, social-networking system 160 may provide users with the ability to take actions on various types of items or objects, supported by social-networking system 160. As an example and not by way of limitation, the items and objects may include groups or social networks to which users of social-networking system 160 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 160 or by an external system of third-party system 170, which is separate from social-networking system 160 and coupled to social-networking system 160 via a network 110.

In particular embodiments, social-networking system 160 may be capable of linking a variety of entities. As an example and not by way of limitation, social-networking system 160 may enable users 101 to interact with each other as well as receive content from third-party systems 170 or other entities, or to allow users 101 to interact with these entities through an application programming interfaces (API) or other communication channels.

In particular embodiments, a third-party system 170 may include one or more types of servers, one or more data stores, one or more interfaces, including but not limited to APIs, one or more web services, one or more content sources, one or more networks, or any other suitable components, e.g., that servers may communicate with. A third-party system 170 may be operated by a different entity from an entity operating social-networking system 160. In particular embodiments, however, social-networking system 160 and third-party systems 170 may operate in conjunction with each other to provide social-networking services to users 101 of social-networking system 160 or third-party systems 170. In this sense, social-networking system 160 may provide a platform, or backbone, which other systems, such as third-party systems 170, may use to provide social-networking services and functionality to users 101 across the Internet.

In particular embodiments, a third-party system 170 may include a third-party content object provider. A third-party content object provider may include one or more sources of content objects, which may be communicated to a client system 130. As an example and not by way of limitation, content objects may include information regarding things or activities of interest to the user 101, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social-networking system 160 also includes user-generated content objects, which may enhance a user's interactions with social-networking system 160. User-generated content may include anything user 101 can add, upload, send, or “post” to social-networking system 160. As an example and not by way of limitation, user 101 communicates posts to social-networking system 160 from a client system 130. Posts may include data such as status updates or other textual data, location information, photos, videos, links, music or other similar data or media. Content may also be added to social-networking system 160 by a third-party through a “communication channel,” such as a newsfeed or stream.

In particular embodiments, social-networking system 160 may include a variety of servers, sub-systems, programs, modules, logs, and data stores. In particular embodiments, social-networking system 160 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 160 may also include suitable components such as network interfaces, security mechanisms, load balancers, failover servers, management-and-network-operations consoles, other suitable components, or any suitable combination thereof.

In particular embodiments, social-networking system 160 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external).

In particular embodiments, user 101 of social-networking system 160 may be represented on one or more graphical user interfaces (GUIs) of social-networking system 160 through presence information indicating a temporal, spatial, modal, or social accessibility or availability of user 101. As an example and not by way of limitation, a profile page associated with user 101 may be hosted by social-networking system 160. Profile pages may also be hosted on third-party websites associated with a third-party server 170. Profile pages may be viewable by all or a selected subset of other users 101 of social-networking system 160. As an example and not by way of limitation, user 101 of social-networking system 160 may have a corresponding user-profile page in which the corresponding user 101 may add content, make declarations, or otherwise express himself or herself. As another example, other example user interfaces (UIs) or webpages in which user 101 may have a presence on social-networking system 160 are a “sidebar” of a “friend's” newsfeed, a group page associated with a particular group whose membership includes user 101, a UI of a mobile computing device, or any combination thereof, as described below. As another example, when the user 101 is a business entity, the business entity may be represented as a business page.

A web server may be used for linking social-networking system 160 to one or more client systems 130 or one or more third-party system 170 via network 110. The web server may include a mail server or other messaging functionality for receiving and routing messages between social-networking system 160 and one or more client systems 130. An API-request server may allow a third-party system 170 to access information from social-networking system 160 by calling one or more APIs. An action logger may be used to receive communications from a web server about a user's actions on or off social-networking system 160. In conjunction with the action log, a third-party-content-object log may be maintained of user exposures to third-party-content objects. A notification controller may provide information regarding content objects to a client system 130. Information may be pushed to a client system 130 as notifications, or information may be pulled from client system 130 responsive to a request received from client system 130. Location stores may be used for storing location information received from client systems 130 associated with users 101. Advertisement-pricing modules may combine social information, the current time, location information, or other suitable information to provide relevant advertisements, in the form of notifications, to the user 101. Third-party-content-object stores may be used to store content objects received from third parties, such as a third-party system 170.

In particular embodiments, social-networking system 160 may include an authorization server (or other suitable component(s)) that allows users 101 to opt in to or opt out of having their actions logged by social-networking system 160 or shared with other systems (e.g., third-party systems 170), for example, by setting appropriate privacy settings. A privacy setting of a user may determine what information associated with the user may be logged, how information associated with the user may be logged, when information associated with the user may be logged, who may log information associated with the user, whom information associated with the user may be shared with, and for what purposes information associated with the user may be logged or shared. Authorization servers may be used to enforce one or more privacy settings of the users of social-networking system 160 through blocking, data hashing, anonymization, or other suitable techniques as appropriate. Authorization servers may be used to enforce one or more privacy settings of the users of social-networking system 160. A privacy setting of user 101 determines how particular information associated with user 101 may be shared. In particular embodiments, a determination of content of displayed by a UI provided by social-networking system 160 for presence information (e.g. a substantially real-time streaming video status of user 101) may be restricted based on the privacy settings of users 101 of social-networking system 160. As an example and not by way of limitation, social-networking system 160 may apply the privacy settings of the user to determine “friends” to invite to share their real-time video statuses, to announce the user is streaming a real-time video status, are allowed to view the real-time video status of the user, or any combination thereof.

FIGS. 2A-D illustrate example wireframes of example user interfaces with example video statuses. Although this disclosure describes or illustrates particular UIs with particular configurations of components and real-time video statuses on a particular computing system, this disclosure contemplates any suitable UIs with any suitable configuration of any suitable components and any suitable real-time video status on any suitable computing system, such as for example a third-party system. As described above, the user may provide presence information on a social-networking system through one or more UIs 50A-D. In particular embodiments, presence information may include a real-time video status 52, such that particular users may observe the status of particular other users of the social-networking system in real time. In particular embodiments, presence information may include pre-recorded video of the user. As described above, an image sensor associated with the client system of the user may automatically and without manual input capture one or more images of the user and send the images to the social-networking system depending on a privacy setting of the user, as appropriate. Furthermore, real-time video status 52 may alternate between images captured by various image sensors depending on a changing geo-location or movement of the user. As an example and not by way of limitation, real-time video status 52 may initially stream a video of the user captured through a web camera of a laptop at a workplace desk and later stream the video from a workplace cafeteria captured through a camera of a mobile computing device.

In the examples illustrated by FIGS. 2A-D, UIs 50A-D may be configured to display presence information, such as for example, one or more real-time video status feeds 52 that are each associated with a user. FIG. 2A illustrates a portion of an example user profile page 50A configured to present a real-time video status 52 of the user. In particular embodiments, a user profile page 50A may be visible to the user, the user's “friends,” or other non-“friend” users depending on privacy settings, as appropriate. User profile page 50A may comprise a number of different components viewable or accessible via selecting one or more interactive elements 54. In the example illustrated in FIG. 2A, user profile page 50A may include a particular photo or picture for display as a cover image 56A. As described above, user profiles may include data that describe the respective users of the social-networking system, such as for example, proper names (first, middle, and last names of a person, a trade name or company name of a business entity, etc.) biographic, demographic, current city of residence, date of birth, hometown, relationship status, or any combination thereof. In particular embodiments, user profile page 50A may also include a summary section 56B that provides a summary of information associated with the user profile described above. In particular embodiments, real-time video status 52 may be embedded with cover image 56A of user profile page 50A. As an example and not by way of limitation, real-time video status 52 may replace a profile photo of user profile page 50A and provide a non-interactive, real-time visual status of the user associated with user profile page 50A. Herein, reference to a “non-interactive, video status” or “video status” may, where appropriate, refer to a one-way stream of images captured by the client system of the user and sent to the social-networking or third-party system.

In particular embodiments, a group or community of users of the social-networking system may be represented on a group page 50B hosted on the social-networking system. FIG. 2B illustrates a portion of an example group page 50B configured to present presence information, such as for example, one or more real-time video statuses 52 of one or more users of the social-networking system that are members of the particular group. In particular embodiments, group page 50B may be visible to the users that are members of the group or other users based on a privacy setting associated with the group, as appropriate. In particular embodiments, group page 50B may comprise components viewable or accessible via selecting one or more interactive elements 54. As an example and not by way of limitation, interactive elements 54 may provide a list of members or group events, files or images uploaded for sharing within the group, or any combination thereof. As another example, members of the particular group may add content (e.g. images, videos, or files), make declarations, or pose questions to other members of the particular group. As illustrated in the example of FIG. 2B, group page 50B may include real-time video status region 40 that may be configured to display one or more non-interactive thumbnail video statuses 52 that each correspond to a member of the particular group. In particular embodiments, video statuses 52 of the real-time video status region 40 may provide the real time status of members of the group that have configured an image sensor to capture a real-time video status 52 of the user.

FIG. 2C illustrates a portion of a UI 50C that includes a “sidebar” 44 with a video status region 40A configured to present presence information, such as for example, a real-time video status 52 of one or more “friends” of the user, a status region 40B of users on the social-networking system, one or more advertisements 42, or any combination thereof. As described above, each user of the social-networking system may have an associated “communication channel,” such as for example a newsfeed, configured to present content objects generated by “friends” of the user. As an example and not by way of limitation, UI 50C may be embedded with newsfeed of a user of the social-networking system. As illustrated in the example of FIG. 2C, real-time video status region 40A may be configured to display one or more non-interactive thumbnail video statuses 52 that each correspond to a real-time status of a “friend” of the user. As described above, video statuses 52 presented in video status region 40A may provide the real-time status of “friends” of the user that have configured an image sensor to capture a real-time video statuses 52.

In particular embodiments, presentation of real-time video statuses 52 in video status region 40A may be adjusted based on one or more criteria. As an example and not by way of limitation, selection of one or more of the real-time video statuses 52 for presentation in video status region 40A may be based on a proximity score of each “friend” to the user based at least in part on social-graph information. For example, “friends” that are connected to the user through an edge, as described below, have a higher proximity score than a “friend” that is connected to the user through another “friend.” As another example, selection of one or more real-time video statuses 52 may be based at least in part on a frequency of interaction between the user and each “friend” with a video status 52. For example, video status 52 of a particular “friend” may be presented in video status region 40A based at least in part on the user exchanging several e-mail messages with the particular “friend.” As another example, video status 52 of a particular “friend” may be presented in video status region 40A based at least in part on an amount of socially relevant interaction between the user and the particular “friends” on the social-networking system, such as for example commenting on status updates, “liking” a post, or writing on the wall of the particular “friend.” In particular embodiments, presentation of video statuses 52 of particular “friends” with whom the user is sharing socially relevant activity may allow the user to gauge the response of each particular “friend” to the socially relevant activity. In particular embodiments, video status region 40A of “sidebar” 44 may be configured to present a real-time video status 52 of particular “friends” in response to the user selecting one or more of the particular “friends” presented in video status region 40A or status region 40B. In particular embodiments, one or more functions may be initiated in response to the user interacting with one or more real-time video statuses 52 presented in video status region 40A. As an example and not by way of limitation, a video chat between the user and one or more particular “friends” may be initiated in response to selecting their real-time video statuses 52. As another example, moving a cursor over one or more video statuses 52 may initiate an increase in size of the selected video status 52. As another example, moving a cursor over one or more video statuses 52 may initiate presentation of a profile “card” that may include profile information described above or video status 52 associated with the selected video status 52.

In particular embodiments, an entity may be represented on a business page 50D hosted on the social-networking system. As illustrated in the example of FIG. 2D, a portion of an example business page 50D may be configured to present presence information, such as for example, a real-time video status 52 associated with the entity. As an example and not by way of limitation, real-time video status 52 may capture images corresponding to activity occurring at a geo-location associated with the entity. Furthermore, real-time video status 52 may function as a cover image of example business page 50D.

In particular embodiments, the user may toggle between initiation and termination of the presentation of presence information, such as for example, real-time video status 52 of the user through a particular interactive element presented on one or more UIs 50A-D of the social-networking system. As an example and not by way of limitation, actuating the particular interactive element may initiate streaming of real-time video status 52 of the user on one or more UIs 50A-D of the social-networking system and subsequent actuation of the particular interactive element may terminate streaming of real-time video status 52. As another example, the particular interactive element may be integrated with the chrome of UIs 50A-D. In particular embodiments, a visual indictor may be presented on one or more UIs 50A-D indicating real-time video status 52 of the user is active.

FIG. 3A illustrates an example mobile computing device. In particular embodiments, the client system may be a mobile computing device 10 as described above. This disclosure contemplates mobile computing device 10 taking any suitable physical form. In particular embodiments, mobile computing device 10 may be a computing system as described below. As example and not by way of limitation, mobile computing device 10 may be a single-board computer system (SBC) (such as, for example, a computer-on-module (COM) or system-on-module (SOM)), a laptop or notebook computer system, a mobile telephone, a smartphone, a personal digital assistant (PDA), a tablet computer system, or a combination of two or more of these. In particular embodiments, mobile computing device 10 may have a touch sensor 12 as an input component. In the example of FIG. 3A, touch sensor 12 is incorporated on a front surface of mobile device 10. In the case of capacitive touch sensors, there may be two types of electrodes: transmitting and receiving. These electrodes may be connected to a controller designed to drive the transmitting electrodes with electrical pulses and measure the changes in capacitance from the receiving electrodes caused by a touch or proximity input. In the example of FIG. 3A, one or more antennae 14A-B may be incorporated into one or more sides of mobile computing device 10. Antennae 14A-B are components that convert electric current into radio waves, and vice versa. During transmission of signals, a transmitter applies an oscillating radio frequency (RF) electric current to terminals of antenna 14A-B, and antenna 14A-B radiates the energy of the applied the current as electromagnetic (EM) waves. During reception of signals, antennae 14A-B convert the power of an incoming EM wave into a voltage at the terminals of antennae 14A-B. The voltage may be transmitted to a receiver for amplification.

Mobile computing device 10 many include a communication component coupled to antennae 14A-B for communicating with an Ethernet or other wire-based network or a wireless NIC (WNIC), wireless adapter for communicating with a wireless network, such as for example a WI-FI network or modem for communicating with a cellular network, such third generation mobile telecommunications (3G), or Long Term Evolution (LTE) network. This disclosure contemplates any suitable network and any suitable communication component for it. As an example and not by way of limitation, mobile computing device 10 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As another example, mobile computing device 10 may communicate with a wireless PAN (WPAN) (such as, for example, a BLUETOOTH WPAN), a WI-FI network, a WI-MAX network, a cellular telephone network (such as, for example, a Global System for Mobile Communications (GSM), 3G, or LTE network), or other suitable wireless network or a combination of two or more of these. Mobile computing device 10 may include any suitable communication component for any of these networks, where appropriate.

In particular embodiments, mobile computing device 10 may include an image sensor configured to capture individual photo images or a series of images at pre-determined intervals as a video status, as described above. An application executed on mobile computing device 10 may provide image management capabilities for images captured through the image sensor of mobile computing device 10. In particular embodiments, an image processing module within mobile computing device 10 may receive images captured by the image sensor. In particular embodiments, one or more images captured by the image sensor may be sent to the social-networking or third-party system through a communication network, described above. In particular embodiments, images captured by the image sensor and stored in the storage component within mobile computing device 10, may be uploaded to the social-networking or third-party system using an application or image-uploading functionality built into the OS of mobile computing device 10. As an example and not by way of limitation, images that are stored on mobile computing device 10 may be automatically uploaded to the social-networking or third-party system. Furthermore, one or more images captured by the image sensor of mobile computing device 10 may be automatically and without input from the user uploaded to the social-networking or third-party system in substantially real-time or at some later time. Although this disclosure illustrates and describes a particular type of mobile computing device, this disclosure contemplates any suitable type of computing device, such as for example, a personal computer, tablet computer, connected television, or a smartphone.

FIG. 3B illustrates an example wireframe for an example user interface with example video statuses on a mobile computing device. In particular embodiments, UI 50E may be an instant messenger or “chat” UI presented on the display of mobile computing device 10. As an example and not by way of limitation, a message region 46 of UI 50E of mobile computing device 10 may be configured to display one or more instant messages generated by the user and “friends” of the user having an online conversation. In particular embodiments, messages 48 may be presented in message region 46 in an order received by the social-networking system. As illustrated in the example of FIG. 3B, UI 50E may include a video status region 40 configured to display presence information, such as for example, one or more real-time video statuses 52. Furthermore, real-time video status 52 of the user that generated each message 48 may be embedded in the corresponding message 48 presented in message region 46. In particular embodiments, selection of one or more of the real-time video statuses 52 presented in video status region 40 may be based at least in part on an exchange of one or more messages 48 between the user and “friends” on the social-networking system. As illustrated in the example of FIG. 3B, real-time video status 52 corresponding to the user and “friends” of the user may be presented in video status 40 while the user and one or more particular “friends” are engaged in an online messaging exchange. As an example and not by way of limitation, presentation of video statuses 52 of particular users with whom the user is sharing socially relevant activity may allow the user to gauge the response of the users during the online exchange of messages 48. Although this disclosure describes or illustrates a particular UI on a mobile computing device presenting particular user-generated content objects, and real-time video status feeds, this disclosure contemplates any suitable UI on a mobile computing device presenting any suitable content objects, such as for example status updates, event invitations, images, or any combination thereof.

FIG. 4 illustrates an example method for providing a real-time video status of a user. The method may start at step 300, where a computing device provides for presentation on a graphical user interface an identification of a user. In particular embodiments, the computing device comprises a social-networking system. At step 302, the computing device provides presence information of the user with the identification of the user, at which point the method may end. In particular embodiments, the presence information indicates a temporal, spatial, modal, or social accessibility of the user. Furthermore, the presence information may include real-time video status of the user captured and provided as presence information automatically and without user input of the user. Although this disclosure describes and illustrates particular steps of the method of FIG. 4 as occurring in a particular order, this disclosure contemplates any suitable steps of the method of FIG. 4 occurring in any suitable order. Moreover, although this disclosure describes and illustrates particular components carrying out particular steps of the method of FIG. 4, this disclosure contemplates any suitable combination of any suitable components carrying out any suitable steps of the method of FIG. 4.

FIG. 5 illustrates example computing system. In particular embodiments, one or more computer systems 60 perform one or more steps of one or more methods described or illustrated herein. In particular embodiments, one or more computer systems 60 provide functionality described or illustrated herein. In particular embodiments, software running on one or more computer systems 60 performs one or more steps of one or more methods described or illustrated herein or provides functionality described or illustrated herein. Particular embodiments include one or more portions of one or more computer systems 60. Herein, reference to a computer system may encompass a computing device, where appropriate. Moreover, reference to a computer system may encompass one or more computer systems, where appropriate.

This disclosure contemplates any suitable number of computer systems 60. This disclosure contemplates computer system 60 taking any suitable physical form. As example and not by way of limitation, computer system 60 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 60 may include one or more computer systems 60; be unitary or distributed; span multiple locations; span multiple machines; span multiple data centers; or reside in a cloud, which may include one or more cloud components in one or more networks. Where appropriate, one or more computer systems 60 may perform without substantial spatial or temporal limitation one or more steps of one or more methods described or illustrated herein. As an example and not by way of limitation, one or more computer systems 60 may perform in real time or in batch mode one or more steps of one or more methods described or illustrated herein. One or more computer systems 60 may perform at different times or at different locations one or more steps of one or more methods described or illustrated herein, where appropriate.

In particular embodiments, computer system 60 includes a processor 62, memory 64, storage 66, an input/output (I/O) interface 68, a communication interface 70, and a bus 72. Although this disclosure describes and illustrates a particular computer system having a particular number of particular components in a particular arrangement, this disclosure contemplates any suitable computer system having any suitable number of any suitable components in any suitable arrangement.

In particular embodiments, processor 62 includes hardware for executing instructions, such as those making up a computer program. As an example and not by way of limitation, to execute instructions, processor 62 may retrieve (or fetch) the instructions from an internal register, an internal cache, memory 64, or storage 66; decode and execute them; and then write one or more results to an internal register, an internal cache, memory 64, or storage 66. In particular embodiments, processor 62 may include one or more internal caches for data, instructions, or addresses. This disclosure contemplates processor 62 including any suitable number of any suitable internal caches, where appropriate. As an example and not by way of limitation, processor 62 may include one or more instruction caches, one or more data caches, and one or more translation lookaside buffers (TLBs). Instructions in the instruction caches may be copies of instructions in memory 64 or storage 66, and the instruction caches may speed up retrieval of those instructions by processor 62. Data in the data caches may be copies of data in memory 64 or storage 66 for instructions executing at processor 62 to operate on; the results of previous instructions executed at processor 62 for access by subsequent instructions executing at processor 62 or for writing to memory 64 or storage 66; or other suitable data. The data caches may speed up read or write operations by processor 62. The TLBs may speed up virtual-address translation for processor 62. In particular embodiments, processor 62 may include one or more internal registers for data, instructions, or addresses. This disclosure contemplates processor 62 including any suitable number of any suitable internal registers, where appropriate. Where appropriate, processor 62 may include one or more arithmetic logic units (ALUs); be a multi-core processor; or include one or more processors 62. Although this disclosure describes and illustrates a particular processor, this disclosure contemplates any suitable processor.

In particular embodiments, memory 64 includes main memory for storing instructions for processor 62 to execute or data for processor 62 to operate on. As an example and not by way of limitation, computer system 60 may load instructions from storage 66 or another source (such as, for example, another computer system 60) to memory 64. Processor 62 may then load the instructions from memory 64 to an internal register or internal cache. To execute the instructions, processor 62 may retrieve the instructions from the internal register or internal cache and decode them. During or after execution of the instructions, processor 62 may write one or more results (which may be intermediate or final results) to the internal register or internal cache. Processor 62 may then write one or more of those results to memory 64. In particular embodiments, processor 62 executes only instructions in one or more internal registers or internal caches or in memory 64 (as opposed to storage 66 or elsewhere) and operates only on data in one or more internal registers or internal caches or in memory 64 (as opposed to storage 66 or elsewhere). One or more memory buses (which may each include an address bus and a data bus) may couple processor 62 to memory 64. Bus 72 may include one or more memory buses, as described below. In particular embodiments, one or more memory management units (MMUs) reside between processor 62 and memory 64 and facilitate accesses to memory 64 requested by processor 62. In particular embodiments, memory 64 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 64 may include one or more memories 64, where appropriate. Although this disclosure describes and illustrates particular memory, this disclosure contemplates any suitable memory.

In particular embodiments, storage 66 includes mass storage for data or instructions. As an example and not by way of limitation, storage 66 may include a hard disk drive (HDD), a floppy disk drive, flash memory, an optical disc, a magneto-optical disc, magnetic tape, or a Universal Serial Bus (USB) drive or a combination of two or more of these. Storage 66 may include removable or non-removable (or fixed) media, where appropriate. Storage 66 may be internal or external to computer system 60, where appropriate. In particular embodiments, storage 66 is non-volatile, solid-state memory. In particular embodiments, storage 66 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 66 taking any suitable physical form. Storage 66 may include one or more storage control units facilitating communication between processor 62 and storage 66, where appropriate. Where appropriate, storage 66 may include one or more storages 66. Although this disclosure describes and illustrates particular storage, this disclosure contemplates any suitable storage.

In particular embodiments, I/O interface 68 includes hardware, software, or both providing one or more interfaces for communication between computer system 60 and one or more I/O devices. Computer system 60 may include one or more of these I/O devices, where appropriate. One or more of these I/O devices may enable communication between a person and computer system 60. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 68 for them. Where appropriate, I/O interface 68 may include one or more device or software drivers enabling processor 62 to drive one or more of these I/O devices. I/O interface 68 may include one or more I/O interfaces 68, where appropriate. Although this disclosure describes and illustrates a particular I/O interface, this disclosure contemplates any suitable I/O interface.

In particular embodiments, communication interface 70 includes hardware, software, or both providing one or more interfaces for communication (such as for example, packet-based communication) between computer system 60 and one or more other computer systems 60 or one or more networks. As an example and not by way of limitation, communication interface 70 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 70 for it. As an example and not by way of limitation, computer system 60 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 60 may communicate with a wireless PAN (WPAN) (such as for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 60 may include any suitable communication interface 70 for any of these networks, where appropriate. Communication interface 70 may include one or more communication interfaces 70, where appropriate. Although this disclosure describes and illustrates a particular communication interface, this disclosure contemplates any suitable communication interface.

In particular embodiments, bus 72 includes hardware, software, or both coupling components of computer system 60 to each other. As an example and not by way of limitation, bus 72 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 72 may include one or more buses 72, where appropriate. Although this disclosure describes and illustrates a particular bus, this disclosure contemplates any suitable bus or interconnect.

FIG. 6 illustrates an example social graph. In particular embodiments, social-networking system 160 may store one or more social graphs 200 in one or more data stores. In particular embodiments, social graph 200 may include multiple nodes—which may include multiple user nodes 202 or multiple concept nodes 204—and multiple edges 206 connecting the nodes. Example social graph 200 illustrated in FIG. 6 is shown, for didactic purposes, in a two-dimensional visual map representation. In particular embodiments, a social-networking system 160, client system 130, or third-party system 170 may access social graph 200 and related social-graph information for suitable applications. The nodes and edges of social graph 200 may be stored as data objects, for example, in a data store (such as a social-graph database). Such a data store may include one or more searchable or queryable indexes of nodes or edges of social graph 200.

In particular embodiments, a user node 202 may correspond to a user of social-networking system 160. As an example and not by way of limitation, a user may be an individual (human user), an entity (e.g. an enterprise, business, or third-party application), or a group (e.g. of individuals or entities) that interacts or communicates with or over social-networking system 160. In particular embodiments, when a user registers for an account with social-networking system 160, social-networking system 160 may create a user node 202 corresponding to the user, and store the user node 202 in one or more data stores. Users and user nodes 202 described herein may, where appropriate, refer to registered users and user nodes 202 associated with registered users. In addition or as an alternative, users and user nodes 202 described herein may, where appropriate, refer to users that have not registered with social-networking system 160. In particular embodiments, a user node 202 may be associated with information provided by a user or information gathered by various systems, including social-networking system 160. As an example and not by way of limitation, a user may provide his or her name, profile picture, contact information, birth date, sex, marital status, family status, employment, education background, preferences, interests, or other demographic information. In particular embodiments, user node 202 may be associated with facial-recognition data extracted from one or more images of the user, depending on a privacy setting of the user. In particular embodiments, a user node 202 may be associated with one or more data objects corresponding to information associated with a user. In particular embodiments, a user node 202 may correspond to one or more webpages.

In particular embodiments, a concept node 204 may correspond to a concept. As an example and not by way of limitation, a concept may correspond to a place (such as, for example, a movie theater, restaurant, landmark, or city); a website (such as, for example, a website associated with social-network system 160 or a third-party website associated with a web-application server); an entity (such as, for example, a person, business, group, sports team, or celebrity); a resource (such as, for example, an audio file, video file, digital photo, text file, structured document, or application) which may be located within social-networking system 160 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 204 may be associated with information of a concept provided by a user or information gathered by various systems, including social-networking system 160. As an example and not by way of limitation, information of a concept may include a name or a title; one or more images (e.g. an image of the cover page of a book); a location (e.g. an address or a geographical location); a website (which may be associated with a URL); contact information (e.g. a phone number or an email address); other suitable concept information; or any suitable combination of such information. In particular embodiments, a concept node 204 may be associated with one or more data objects corresponding to information associated with concept node 204. In particular embodiments, a concept node 204 may correspond to one or more webpages.

In particular embodiments, a node in social graph 200 may represent or be represented by a webpage (which may be referred to as a “profile page”). Profile pages may be hosted by or accessible to social-networking system 160. Profile pages may also be hosted on third-party websites associated with a third-party server 170. As an example and not by way of limitation, a profile page corresponding to a particular external webpage may be the particular external webpage and the profile page may correspond to a particular concept node 204. Profile pages may be viewable by all or a selected subset of other users. As an example and not by way of limitation, a user node 202 may have a corresponding user-profile page in which the corresponding user may add content, make declarations, or otherwise express himself or herself. As another example and not by way of limitation, a concept node 204 may have a corresponding concept-profile page in which one or more users may add content, make declarations, or express themselves, particularly in relation to the concept corresponding to concept node 204.

In particular embodiments, a concept node 204 may represent a third-party webpage or resource hosted by a third-party system 170. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check in,” “eat,” “recommend,” or another suitable action or activity. A user viewing the third-party webpage may perform an action by selecting one of the icons (e.g. “eat”), causing a client system 130 to transmit to social-networking system 160 a message indicating the user's action. In response to the message, social-networking system 160 may create an edge (e.g. an “eat” edge) between a user node 202 corresponding to the user and a concept node 204 corresponding to the third-party webpage or resource and store edge 206 in one or more data stores.

In particular embodiments, a pair of nodes in social graph 200 may be connected to each other by one or more edges 206. An edge 206 connecting a pair of nodes may represent a relationship between the pair of nodes. In particular embodiments, an edge 206 may include or represent one or more data objects or attributes corresponding to the relationship between a pair of nodes. As an example and not by way of limitation, a first user may indicate that a second user is a “friend” of the first user. In response to this indication, social-networking system 160 may transmit a “friend request” to the second user. If the second user confirms the “friend request,” social-networking system 160 may create an edge 206 connecting the first user's user node 202 to the second user's user node 202 in social graph 200 and store edge 206 as social-graph information in one or more of data stores 24. In the example of FIG. 6, social graph 200 includes an edge 206 indicating a friend relation between user nodes 202 of user “A” and user “B” and an edge indicating a friend relation between user nodes 202 of user “C” and user “B.” Although this disclosure describes or illustrates particular edges 206 with particular attributes connecting particular user nodes 202, this disclosure contemplates any suitable edges 206 with any suitable attributes connecting user nodes 202. As an example and not by way of limitation, an edge 206 may represent a friendship, family relationship, business or employment relationship, fan relationship, follower relationship, visitor relationship, subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 200 by one or more edges 206.

In particular embodiments, an edge 206 between a user node 202 and a concept node 204 may represent a particular action or activity performed by a user associated with user node 202 toward a concept associated with a concept node 204. As an example and not by way of limitation, as illustrated in FIG. 6, a user may “like,” “attended,” “played,” “listened,” “cooked,” “worked at,” or “watched” a concept, each of which may correspond to a edge type or subtype. A concept-profile page corresponding to a concept node 204 may include, for example, a selectable “check in” icon (such as, for example, a clickable “check in” icon) or a selectable “like” icon. As another example, the socialized dash of a client system may include a selectable “check in” icon (such as, for example, a clickable “check in” icon) or a selectable “like” icon. Similarly, after a user clicks these icons, social-networking system 160 may create a “like” edge or a “check in” edge in response to a user's action corresponding to a respective action. As another example and not by way of limitation, a user (user “C”) may listen to a particular song (“Ramble On”) using a particular application (SPOTIFY, which is an online music application). In this case, social-networking system 160 may create a “listened” edge 206 and a “used” edge (as illustrated in FIG. 6) between user nodes 202 corresponding to the user and concept nodes 204 corresponding to the song and application to indicate that the user listened to the song and used the application. Moreover, social-networking system 160 may create a “played” edge 206 (as illustrated in FIG. 6) between concept nodes 204 corresponding to the song and the application to indicate that the particular song was played by the particular application. In this case, “played” edge 206 corresponds to an action performed by an external application (SPOTIFY) on an external audio file (the song “Imagine”). Although this disclosure describes particular edges 206 with particular attributes connecting user nodes 202 and concept nodes 204, this disclosure contemplates any suitable edges 206 with any suitable attributes connecting user nodes 202 and concept nodes 204. Moreover, although this disclosure describes edges between a user node 202 and a concept node 204 representing a single relationship, this disclosure contemplates edges between a user node 202 and a concept node 204 representing one or more relationships. As an example and not by way of limitation, an edge 206 may represent both that a user likes and has used at a particular concept. Alternatively, another edge 206 may represent each type of relationship (or multiples of a single relationship) between a user node 202 and a concept node 204 (as illustrated in FIG. 6 between user node 202 for user “E” and concept node 204 for “SPOTIFY”).

In particular embodiments, social-networking system 160 may create an edge 206 between a user node 202 and a concept node 204 in social graph 200. As an example and not by way of limitation, a user viewing a concept-profile page (such as, for example, by using a web browser or a special-purpose application hosted by the user's client system 130) may indicate that he or she likes the concept represented by the concept node 204 by clicking or selecting a “Like” icon, which may cause the user's client system 130 to transmit to social-networking system 160 a message indicating the user's liking of the concept associated with the concept-profile page. In response to the message, social-networking system 160 may create an edge 206 between user node 202 associated with the user and concept node 204, as illustrated by “like” edge 206 between the user and concept node 204. In particular embodiments, social-networking system 160 may store an edge 206 in one or more data stores. In particular embodiments, an edge 206 may be automatically formed by social-networking system 160 in response to a particular user action. As an example and not by way of limitation, if a first user uploads a picture, watches a movie, or listens to a song, an edge 206 may be formed between user node 202 corresponding to the first user and concept nodes 204 corresponding to those concepts. Although this disclosure describes forming particular edges 206 in particular manners, this disclosure contemplates forming any suitable edges 206 in any suitable manner.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A method comprising:
by a computing device, providing for presentation on a graphical user interface an identification of a first user; and
by the computing device, providing presence information of the first user with the identification of the first user, the presence information indicating a temporal, spatial, modal, or social accessibility or availability of the first user, the presence information comprising real-time video of the first user captured and provided as presence information automatically and without user input of the first user.

2. The method of claim 1, wherein the graphical user interface is a profile page of the first user on a social-networking system.

3. The method of claim 1, further comprising:
providing for presentation on the graphical user interface an identification of one or more second users, the second users having a relationship with the first user based at least in part on social-graph information; and
by the computing device, providing presence information of each of the second users with the identification of each of the second users.

4. The method of claim 3, wherein the social graph comprises a plurality of nodes and edges connecting the nodes;
at least one node in the graph corresponds to the first user; and
at least one node in the graph corresponds to one of the second users.

5. The method of claim 3, wherein the graphical user interface is a newsfeed and further comprises one or more status updates generated by the first or one of more of the second users.

6. The method of claim 3, wherein the first and second users are members of a group and the graphical user interface is a group page on a social-networking system.

7. The method of claim 3, wherein the graphical user interface further comprises one or more messages generated by the first and one of more of the second users that comprise a real-time online conversation on a social-networking system.

8. The method of claim 1, wherein:
the first user is a business entity;
the graphical user interface is a business page on a social-networking system; and
the real-time video comprises one or more images corresponding to activity of a geo-location associated with the business entity.

9. One or more computer-readable non-transitory storage media embodying software configured when executed to:
provide for presentation on a graphical user interface an identification of a first user; and
provide presence information of the first user with the identification of the first user, the presence information indicating a temporal, spatial, modal, or social accessibility or availability of the first user, the presence information comprising real-time video of the first user captured and provided as presence information automatically and without user input of the first user.

10. The media of claim 9, wherein the graphical user interface is a profile page of the first user on a social-networking system.

11. The media of claim 9, wherein the software is further configured to:
provide for presentation on the graphical user interface an identification of one or more second users, the second users having a relationship with the first user based at least in part on social-graph information; and
provide presence information of each of the second users with the identification of each of the second users.

12. The media of claim 11, wherein the social graph comprises a plurality of nodes and edges connecting the nodes;
at least one node in the graph corresponds to the first user; and
at least one node in the graph corresponds to one of the second users.

13. The media of claim 11, wherein the graphical user interface is a newsfeed and further comprises one or more status updates generated by the first or one of more of the second users.

14. The media of claim 11, wherein the first and second users are members of a group and the graphical user interface is a group page on a social-networking system.

15. The media of claim 11, wherein the graphical user interface further comprises one or more messages generated by the first and one of more of the second users that comprise a real-time online conversation on a social-networking system.

16. The media of claim 9, wherein:
the first user is a business entity;
the graphical user interface is a business page on a social-networking system; and
the real-time video comprises one or more images corresponding to activity of a geo-location associated with the business entity.

17. A device comprising:
a processor; and
one or more computer-readable non-transitory storage media coupled to the processor and embodying software that:
provide for presentation on a graphical user interface an identification of a first user; and
provide presence information of the first user with the identification of the first user, the presence information indicating a temporal, spatial, modal, or social accessibility or availability of the first user, the presence information comprising real-time video of the first user captured and provided as presence information automatically and without user input of the first user.

18. The device of claim 17, wherein the graphical user interface is a profile page of the first user on a social-networking system.

19. The device of claim 17, wherein the software is further configured to:
provide for presentation on the graphical user interface an identification of one or more second users, the second users having a relationship with the first user based at least in part on social-graph information; and
provide presence information of each of the second users with the identification of each of the second users.

20. The device of claim 17, wherein the graphical user interface is a newsfeed and further comprises one or more status updates generated by the first or one of more of the second users.
